(19) United States
(12) Patent Application Publication
(10) Pub. No.: US 2014/0224552 A1
(43) Pub. Date: Aug. 14, 2014

(54) BODY WEIGHT MANAGEMENT DEVICE

(71) Applicants: Satoe Shimizu, Kyoto (JP); Wataru Date, Kyoto (JP); Teppei Sumino, Kyoto (JP)

(72) Inventors: Satoe Shimizu, Kyoto (JP); Wataru Date, Kyoto (JP); Teppei Sumino, Kyoto (JP)

(73) Assignee: OMRON HEALTHCARE CO., LTD., Muko-shi, Kyoto (JP)

(21) Appl. No.: 14/347,026

(22) PCT Filed: Jun. 8, 2012
(86) PCT No.: PCT/JP2012/064758

§ 371 Date: Mar. 25, 2014

(30) Foreign Application Priority Data
Sep. 26, 2011 (JP) 2011-208661

(51) Int. Cl. G06F 19/00; G01G 19/44

(52) U.S. Cl. CPC G06F 19/3475; G01G 19/44
USPC 177/25.13

(57) ABSTRACT

A body weight management device includes a body weight obtainment configured to obtain body weight data that includes a measurement subject's body weight measurement value at a predetermined intra-day timing between waking up and sleeping and a measurement date/time of the body weight measurement value, a body weight storage unit configured to store the body weight data obtained by the body weight obtainment unit in a memory, a representative body weight calculation unit configured to calculate a representative body weight value based on the body weight measurement values in the body weight data in a predetermined period, which are stored in the memory, and a target calculation unit configured to calculate a target value to be a target when a body weight value is measured at the predetermined timing, based on the calculated representative body weight value, an intra-day target weight-loss value, and a measurement value to be a weight variation factor.

### BACKGROUND OF THE INVENTION

1. Field of the Invention

The present invention relates to body weight management devices, and particularly relates to body weight management devices for use in managing a measurement subject's body weight using a target value.

2. Description of the Related Art

Conventionally, there has been a desire for the provision of a function for managing body weight for the purpose of weight loss in order to prevent obesity. For example, JP 2010-181377A and JP 2008-304421A disclose devices that calculate target values based on intra-day weight variation. Additionally, with JP 2007-226775A, a deviation of actual body weight from target body weight is calculated in units of days. Additionally, with JP 2010-237805A, target weight loss is calculated in accordance with an equation (current body weight-target body weight).

With JP 2010-181377A and JP 2008-304421A, body weight measurement is needed not less than two times in the same day in order to measure intra-day body weight variation. Also, although body weight generally fluctuates depending on daily amount of food and drink, as well as on the time of measurement, due to the fact that a target value is calculated without giving consideration to these factors in JP 2007-226775A and JP 2010-237805A, the calculated target values have a wide variation, ranging from values at which weight loss is excessive to values at which the effect of weight loss is not achieved.

### SUMMARY OF THE INVENTION

Accordingly, preferred embodiments of the present invention provide a body weight management device that calculates a target value for weight loss, based on data regarding body weight measurement that is performed once per day.

A body weight management device according to an aspect of a preferred embodiment of the present invention includes: a body weight obtainment unit configured to obtain body weight data that includes a measurement subject's body weight measurement value at an intra-day predetermined timing between waking up and sleeping, and a measurement date/time of the body weight measurement value; a body weight storage unit configured to store body weight data obtained by the body weight obtainment unit in a memory; a representative body weight calculation unit configured to calculate a representative body weight value based on the body weight measurement values in the body weight data in a predetermined period, which are stored in the memory; and a target calculation unit configured to calculate a target value to be a target when a body weight value is measured at the predetermined timing, based on the calculated representative body weight value, an intra-day target weight-loss value, and a measurement value to be a body weight variation factor.

According to various preferred embodiments of the present invention, a target value for weight loss giving consideration to body weight variation factors is calculated based on body weight data according to a one-time body weight measurement at a predetermined intra-day timing.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating the external appearance of a body composition meter according to a preferred embodiment of the present invention.

FIG. 2 is a block diagram illustrating an example of a configuration of the body composition meter and a server according to a preferred embodiment of the present invention.

FIG. 3 is a diagram illustrating the functional configuration for body weight management included in the body weight/body composition meter according to a preferred embodiment of the present invention.

FIG. 4 is a diagram illustrating the functional configuration of a variation factor obtainment unit according to a preferred embodiment of the present invention.

FIG. 5 is a diagram illustrating the functional configuration for body weight management included in the server according to a preferred embodiment of the present invention.

FIGS. 6A-6F are diagrams illustrating various types of data held in a storage unit according to a preferred embodiment of the present invention.

FIG. 7 is a main flowchart according to a preferred embodiment of the present invention.

FIG. 8 is a flowchart illustrating an analysis process according to a preferred embodiment of the present invention.

FIG. 9 is a flowchart illustrating processing for obtaining a variation factor using a body water amount according to a preferred embodiment of the present invention.

FIG. 10 is a flowchart illustrating processing for obtaining a variation factor using measurement times according to a preferred embodiment of the present invention.

FIG. 11 is a diagram for describing a regression equation derived from a measured body weight value according to a preferred embodiment of the present invention.

FIG. 12 is a diagram illustrating an example of a display according to a preferred embodiment of the present invention.

FIG. 13 is a diagram for describing a nighttime body weight decrease according to a preferred embodiment of the present invention.

FIG. 14 is a diagram for describing a procedure for obtaining an average nighttime body weight decrease according to a preferred embodiment of the present invention.

FIG. 15 is a diagram illustrating an example of a display according to a preferred embodiment of the present invention.

FIG. 16 is a diagram for describing a procedure for predicting a target value based on nighttime body weight decrease and a change in morning body weight according to a preferred embodiment of the present invention.

FIG. 17 is a diagram for describing a procedure for predicting a target value based on nighttime body weight decrease and a change in morning body weight according to a preferred embodiment of the present invention.

### DETAILED DESCRIPTION OF THE PREFERRED EMBODIMENTS

Hereinafter, preferred embodiments of the present invention will be described in detail with reference to the drawings.

Note that in the following preferred embodiments, identical or corresponding elements are given the same reference numerals in the drawings, and descriptions thereof will not be repeated.

First, example non-limiting definitions will be given for certain terms. In the present preferred embodiment, “morning time” refers, with respect to body weight measurement, to a period of time spanning from, for example 4 AM to noon (12 PM), whereas “evening time” indicates a period of time spanning from, for example, 7 PM to 2 AM. “Morning body weight” refers to a body weight measured during the morning time, whereas “evening body weight” refers to a body weight measured during the evening time. To simplify the descriptions, it is assumed that the body weight is measured immediately before going to bed for sleeping (evening body weight), and that the body weight is measured immediately after waking up (morning body weight).

Here, “intra-day” refers to a single day, from the waking time to the sleeping time of a measurement subject, and the body weight is measured once at a predetermined timing between waking and sleeping.

“Nighttime body weight decrease” refers to a decrease in body weight during sleep caused primarily by basal metabolism, such as perspiration, occurring during the period from the sleeping time to the waking time. “Intra-day target weight loss value” refers to a body weight loss value to be used as an intra-day target.

In the present preferred embodiment, a body weight/body composition meter capable of obtaining not only a body weight but also a given type of body composition information, such as a body fat percentage, by simultaneously measuring a body impedance (hereinafter simply referred to as “impedance”), is illustrated as an example of a body weight management device, but a device that only is configured to measure a body weight may be used as well, for example. In such a case, it is assumed that the impedance is received from another measurement device.

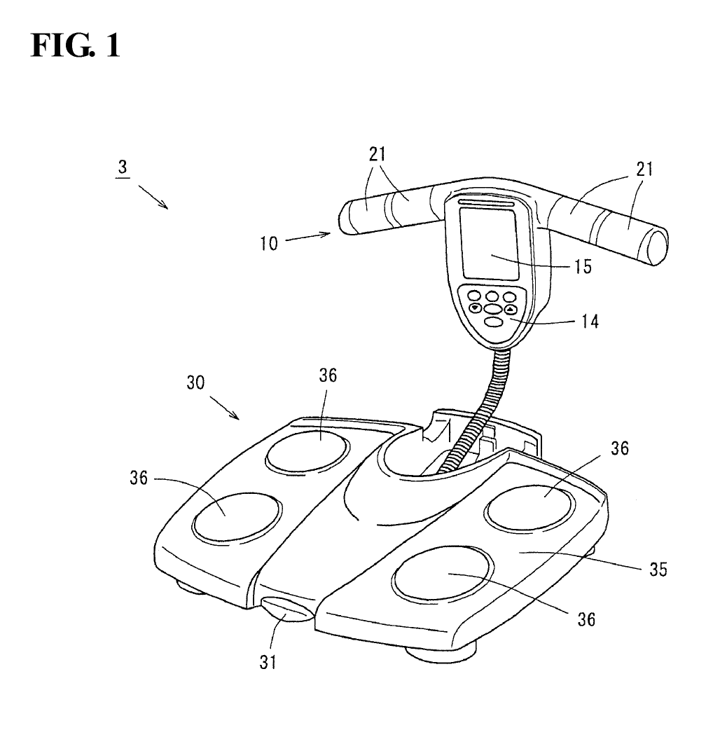

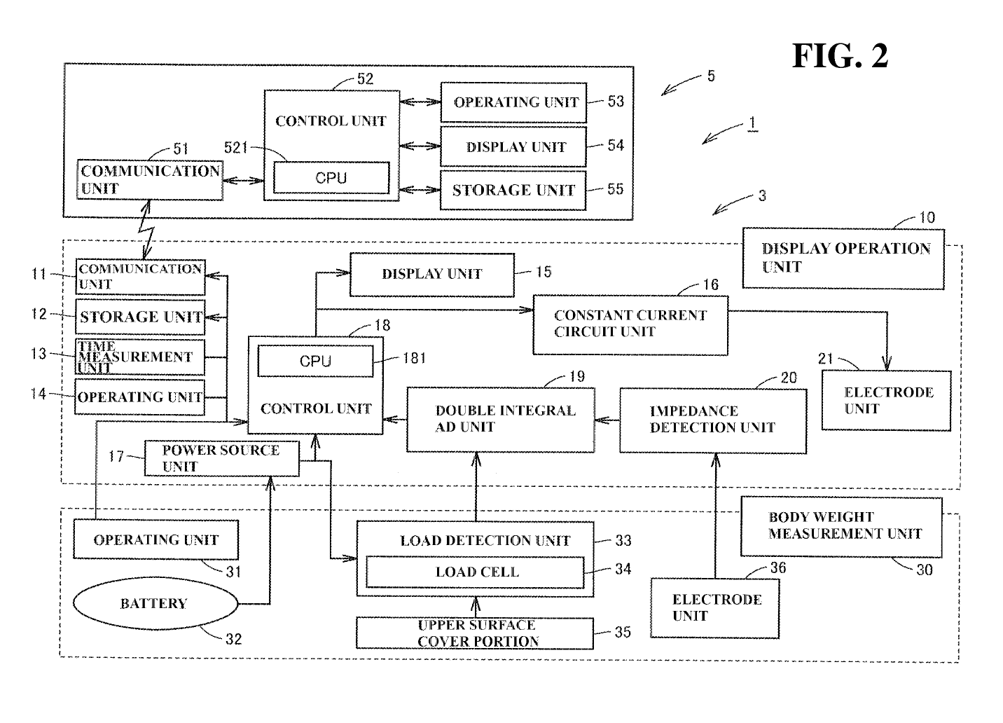

FIG. 1 illustrates the external appearance of a body weight/body composition meter 3, whereas FIG. 2 illustrates the configuration of a body weight management system 1.

The body weight management system 1 shown in FIG. 2 includes the body weight/body composition meter 3 and a server (server computer) 5 that communicates with the body weight/body composition meter 3. To simplify the descriptions, FIG. 2 illustrates a single body weight/body composition meter 3 being connected to the server 5, but multiple body weight/body composition meters 3 may be connected. In FIG. 2, the body weight/body composition meter 3 and the server 5 communicate wirelessly or over wires. Note that the exchange of data between the body weight/body composition meter 3 and the server 5 is not limited to communications, and the exchange may take place via a storage medium, for example.

As shown in FIG. 1, the body weight/body composition meter 3 includes a display/operating unit 10, which preferably includes a first housing member held by a measurement subject's hand, and a body weight measurement unit 30, which includes a second housing member onto which the measurement subject steps.

The display/operating unit 10 includes, as shown in FIG. 2, a communication unit 11, a storage unit 12, a timer unit 13, an operating unit 14, a display unit 15, a constant current circuit unit 16, a power source unit 17, a control unit 18 that includes a CPU (central processing unit) 181, a double integral AD (analog/digital) unit 19, an impedance detection unit 20, and electrode units 21.

The communication unit 11 is connected to the control unit 18, and communicates with the server 5 in accordance with a control signal from the control unit 18. Note that the communication unit 11 is not limited to communicating with the server 5; the communication unit 11 may communicate with any appropriate device, including another body information obtainment device such as a pedometer or the like, or a personal computer, mobile information terminal (a PDA (personal digital assistant), a mobile telephone, or the like), and so on.

The storage unit 12 includes an apparatus that can store information, such as a non-volatile memory, a hard disk, or the like. The storage unit 12 is configured to have information read out therefrom and written thereto in accordance with a control signal from the control unit 18, to which the storage unit 12 is connected.

The timer unit 13 is a device including a timer or a counter that measures a time instant such as the current date/time, and outputs the time instant to the control unit 18.

The operating unit 14 includes multiple buttons, switches, or the like (see FIG. 1) that are operated by being depressed or the like. By manipulating the operating unit 14, the measurement subject can input his/her personal information and body information, such as personal identifier, sex, age, height, body weight, and so on. The input information is supplied to the control unit 18.

The display unit 15 includes a display device such as a liquid-crystal display (see FIG. 1), and displays images such as text, graphics, or the like in accordance with an image signal supplied from the control unit 18. The constant current circuit unit 16 applies a high-frequency (AC) current supplied from the power source unit 17 to current application electrode units 21 in a single direction, under the control of the control unit 18. The power source unit 17 supplies operational electricity to the respective elements, including the control unit 18.

The control unit 18 preferably is configured of a MICOM (microcomputer) that includes the CPU 181, a ROM (read-only memory), and a RAM (random access memory) (not shown), and executes control operations and computational operations for the respective constituent elements in accordance with programs and data stored in the ROM or the like. These programs and data include programs and data for body weight management.

The double integral AD unit 19 is a double integral-type AD conversion unit. During operations, the double integral AD unit 19 converts an analog signal (a voltage signal) output from the impedance detection unit 20 into a digital signal and outputs that digital signal to the control unit 18.

The impedance detection unit 20 is configured to detect an impedance of the measurement subject based on a potential difference between electrode units 36 provided in the body weight measurement unit 30 and the electrode units 21 provided in the display/operating unit 10.

The electrode units 21 are provided on the surfaces of grip portions (see FIG. 1) in the display/operating unit 10, which are held in the measurement subject's hand. The electrode units 21 apply the high-frequency (AC) current, supplied from the power source unit 17, to the palms of the measurement subject's hands that are gripping the grip portions.

The body weight measurement unit 30 includes an operating unit 31, a battery 32, a load detection unit 33, and the electrode units 36. The operating unit 31 functions as an input switch that is manipulated in order to switch the power on or off, and when the operating unit 31 is manipulated, an input signal is output to the control unit 18 in response to that manipulation. The battery 32 supplies power to the respective elements, and in particular, to the power source unit 17.

The load detection unit 33 includes multiple load cells 34 provided therein. The load detection unit 33 measures the body weight of the measurement subject that has stepped onto an upper surface cover unit 35 (see FIG. 1) that also serves as an upper surface cover of the housing member. The measured body weight is output to the double integral AD unit 19.

The electrode units 36 are preferably provided in the surface of the upper surface area of the body weight measurement unit 30 (see FIG. 1) onto which the measurement subject steps, and serve as current measurement electrodes that detect a current that flows from the soles of the measurement subject's feet. The electrode units 36 preferably include four electrodes that make contact with the left toe side, the left heel side, the right toe side, and the right heel side of the measurement subject's feet, for example.

Each of the load cells 34 in the load detection unit 33 is disposed so as to be able to measure a load placed on the upper surface area of the body weight measurement unit 30, and here, are disposed below the respective electrodes in the electrode units 36. Accordingly, both the impedance and the body weight can be measured at the same time when the measurement subject steps upon the upper surface area.

During body weight measurement, a load produced by the measurement subject's body weight is exerted on the load cells 34. Each of the load cells 34 preferably includes a bending member including a metal member that deforms in response to a load exerted thereon, and a strain gauge that is applied to the bending member. When the bending member bends, the strain gauge extends/contracts, and a resistance value changes in accordance with the extension/contraction of the strain gauge; the change in resistance is then derived as a load signal output. Accordingly, in the case where the measurement subject has stepped onto the upper surface area and both feet have been placed on the load cells 34, the bending member will bend due to the measurement subject's body weight that has been applied to the load cells 34, and the body weight will be measured as a change in the aforementioned load signal output.

Although the load cells 34 are preferably used in the present preferred embodiment as load sensors to detect a load, it should be noted that a sensor that includes, for example, springs, a piezoelectric film, or the like, a compression element, a displacement sensor, or the like may be used as long as that element is capable of detecting the amount of a force applied to the upper surface area.

The server 5 includes a communication unit 51, a control unit 52 preferably defined by a computer including a CPU 521, a ROM, and a RAM, an operating unit 53, a display unit 54, and a storage unit 55.

The communication unit 51 exchanges data with the body weight/body composition meter 3 under the control of the control unit 52. The CPU 521 of the control unit 52 is programmed to control the operations of the respective elements and executes various types of computations in accordance with programs and data stored in the ROM or the like.

The operating unit 53 includes a keyboard, a mouse, or the like. Signals input as a result of operations performed by an operator are output to the control unit 52.

The display unit 54 corresponds to a liquid-crystal display, a CRT (cathode ray tube) display, or the like. The display unit 54 displays images such as graphics, text, or the like in accordance with a control signal supplied from the control unit 52.

The storage unit 55 corresponds to a fixed storage device such as a hard disk, or a recording medium that can be read by the computer that includes the CPU 521, such as a flexible disk, a CD-ROM (compact disk read-only memory), a ROM (read-only memory), a RAM (random access memory), a memory card, and so on.

The storage unit 55 stores data measured by the body weight/body composition meter 3 (body composition information, body weight data, measurement date/time data, and so on), various types of data related to the measurement subject, including the personal information such as the measurement subject's name (identifier), address, and so on, as well as body information (sex, height, age, and so on).

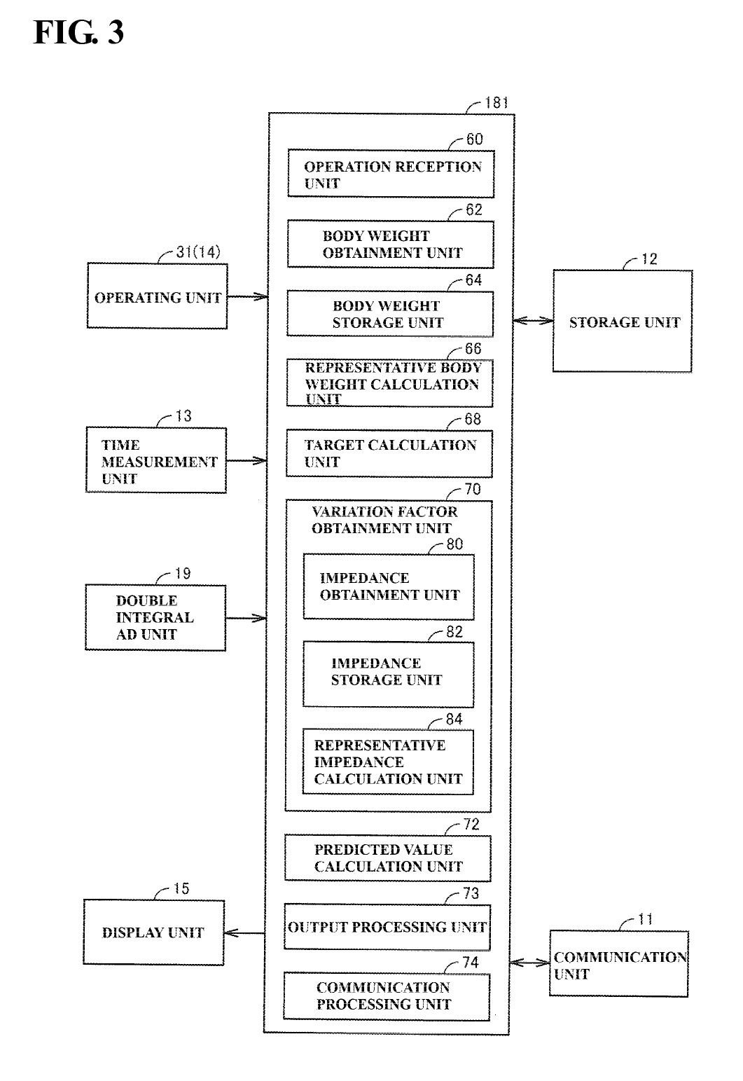

The functional configuration of the body weight/body composition meter 3, as related to body weight management, will be described with reference to FIG. 3. FIG. 3 illustrates functions included in the CPU 181, and related peripheral circuits.

The CPU 181 includes an operation reception unit 60 that receives user operations via the operating units 31 and 14 and outputs operation signals based on the received operations, a body weight obtainment unit 62 configured to obtain body weight data including a body weight measurement value and a measurement date/time, a body weight storage unit 64 configured to the obtained body weight data in a predetermined region of the storage unit 12, a representative body weight calculation unit 66, a target calculation unit 68, a variation factor obtainment unit 70 configured to obtain measurement values to be body weight variation factors, a predicted value calculation unit 72 configured to calculate a predicted body weight value, an output processing unit 73 configured to display information on the display unit 15, and a communication processing unit 74 configured to communicate with external devices including the server 5 via the communication unit 11.

The representative body weight calculation unit 66 calculates a representative body weight value based on body weight measurement values included in the body weight data that was obtained during the most recent predetermined time period and that is stored in the storage unit 12. Based on the calculated representative body weight value, the intra-day target weight loss value, and the measurement value that is a body weight variation factor, the target calculation unit 68 calculates a target value to be the target when measuring a body weight value.

The variation factor obtainment unit 70 includes an impedance obtainment unit 80 configured to obtain impedance data that includes an impedance value measured at the time of the measurement subject's body weight measurement, and the date/time of that measurement, an impedance storage unit 82 configured to store the obtained impedance data in the storage unit 12, and a representative impedance calculation unit 84. The representative impedance calculation unit 84 calculates a representative impedance value based on impedance values in the impedance data in the most recent predetermined time period, which are stored in the memory unit 12. The variation factor obtainment unit 70 calculates an amount of body water based on a differential impedance value, which is the difference between the calculated representative impedance value and the most recently measured impedance value, as a measurement value that is a body weight variation factor.

These elements are realized by programs executed by the CPU 181. These programs are stored in advance in the ROM (not shown) of the control unit 18. The functions of the respective elements are realized by the CPU 181 reading out the programs from the ROM and executing the commands in the read-out programs. The programs may be downloaded by the communication unit 11 from an external device, such as the server 5, stored in the storage unit 12, and subsequently read out from the storage unit 12 by the CPU 181 and executed.

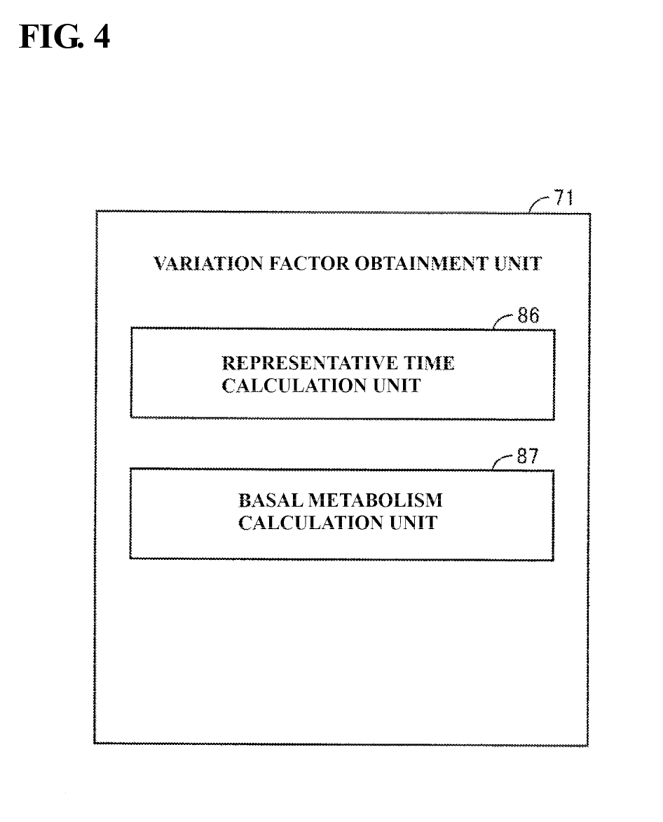

The variation factor obtainment unit 71 in FIG. 4 may be included in place of, or along with the variation factor obtainment unit 70 in FIG. 3. If the variation factor obtainment units 70 and 71 are both included, the measurement subject can select one function to be performed by performing an operation on the operating unit 14 (or the operating unit 31). Note that the variation factor obtainment unit 71 in FIG. 4 will be described in detail later.

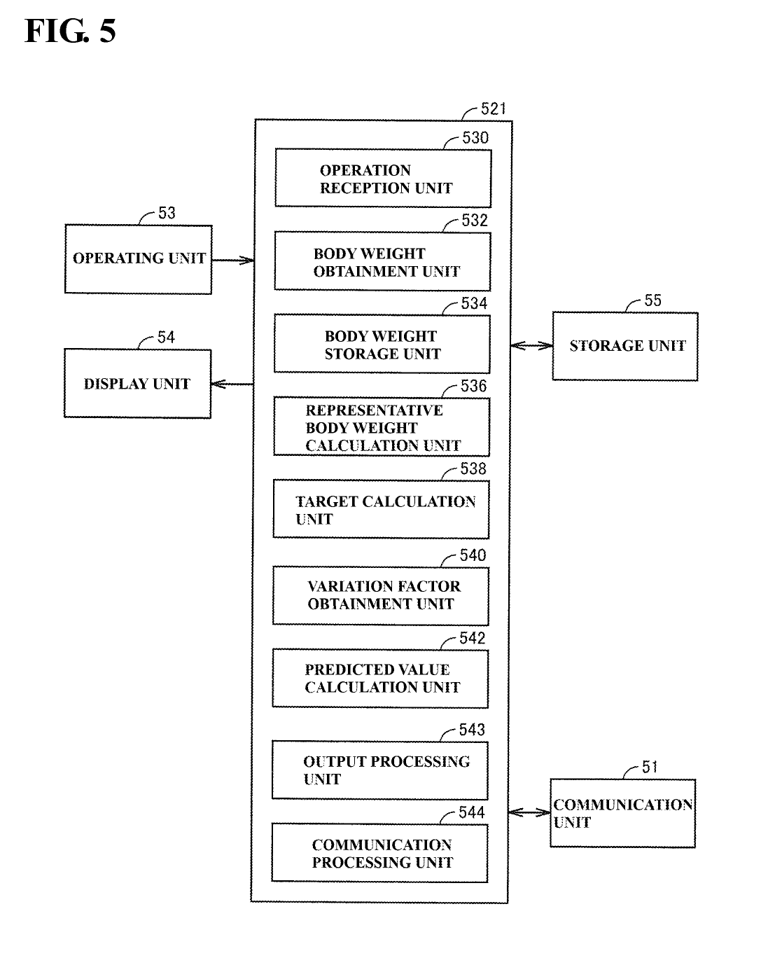

Additionally, body weight management functions according to the present preferred embodiment may be realized by the CPU 521 in the server 5 that has the functions in FIG. 5. The server 5 in FIG. 5 will be described in detail later.

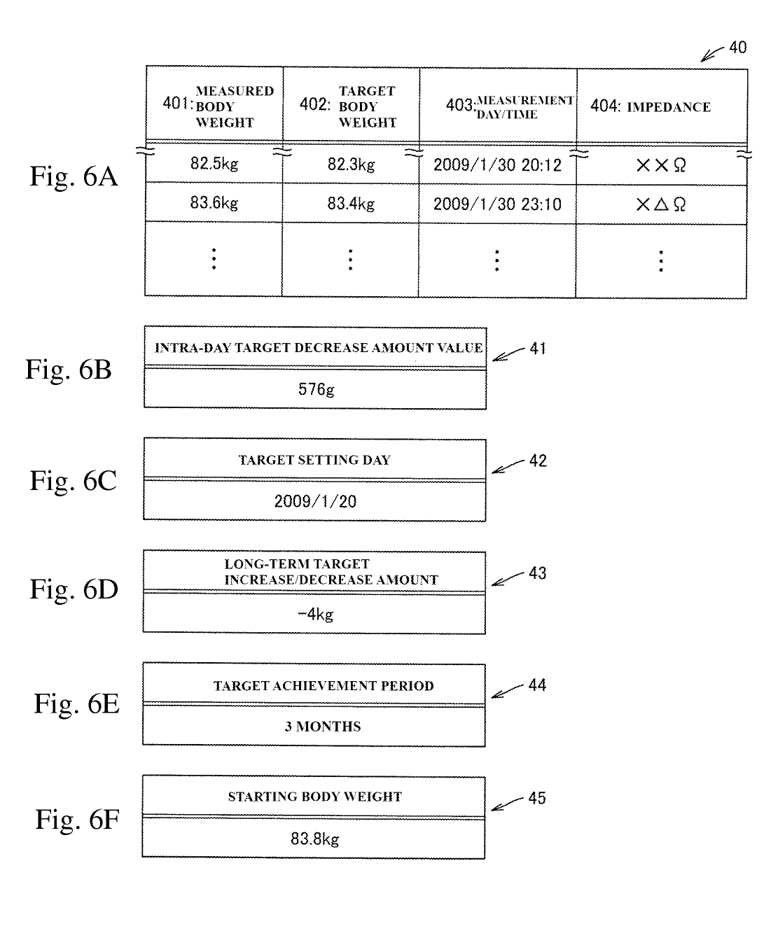

The various types of data stored in the storage unit 12 will be described with reference to FIGS. 6A-6F. If the body weight/body composition meter 3 is used in common by multiple measurement subjects, the data in FIGS. 6A-6F is stored for each measurement subject. Here, in order to simplify the descriptions, it is assumed that the body weight/body composition meter 3 is used by one measurement subject.

Body weight data measured by the body weight measurement unit 30 is stored in the storage unit 12 as measurement data 40 shown in FIG. 6A, each time measurement is performed. Data 401 that indicates an actually-measured body weight value, data 402 that indicates a body weight value that is the target value calculated by the target calculation unit 68, data 403 that indicates a date/time of measurement based on time measurement data from the time measurement unit 13, and data 404 that indicates an impedance value measured at the same time as the body weight measurement are included in the measurement data 40 in association with each other. The aforementioned body weight data is indicated by the data 401 and 403, and the aforementioned impedance data is indicated by the data 404 and 403.

Although it is assumed that the data 404 indicates an impedance value measured by the impedance detection unit 20 at the time of body weight measurement, the method of obtaining the data 404 is not limited to this. For example, impedance may be measured by another device, the value thereof may be received via the communication unit 11 and stored in the storage unit 12 as the data 404, or a value input by the measurement subject using the operating unit 14 (or the operating unit 31) may be stored in the storage unit 12 as the data 404. In any case, the impedance indicated by the data 404, and the body weight value indicated by the data 401 in the measurement data 40 indicate values measured at substantially the same time. The memory unit 12 has a capacity that enables multiple weeks' worth or several months' worth of measurement data 40 to be stored.

Intra-day target weight-loss value data 41 shown in FIG. 6B indicates a single-day body weight loss value to achieve the measurement subject's target weight loss.

Target setting day data 42 is indicated in FIG. 6C. The target setting day data 42 indicates the date on which the measurement subject started body weight management such as a diet using the body weight/body composition meter 3. In other words, it indicates the date on which the data shown in FIGS. 6B to 6F for body weight management was set (input) by the measurement subject.

Long-term target increase/decrease amount data 43, shown in FIG. 6D, indicates a target value for a body weight increase/decrease amount input by the measurement subject operating the operating unit 14. In the present preferred embodiment, negative values are input since the body weight management is for weight loss.

A target achievement period set by the measurement subject operating the operating unit 14 is stored as the target achievement period data 44, shown in FIG. 6E. The target achievement period is a period, which is indicated in the long-term target increase/decrease amount data 43, by the end of which weight loss is to be achieved.

The CPU 181 determines, as appropriate, whether or not an intra-day increase/decrease amount that serves as a daily norm, obtained by dividing the long-term target increase/decrease amount by the number of days of the target achievement period, falls within a predetermined range. In the case where it is determined that the amount is outside of the predetermined range, an error display is shown on the display unit 15 via an output processing unit 73. The measurement subject is then prompted to re-input the target achievement period until the amount is determined to fall within a predetermined range. Through this, excessive weight loss that places a burden on the measurement subject's body can be avoided.

The intra-day increase/decrease amount that is determined to be appropriate is stored in the storage unit 12 as the intra-day target weight-loss value data 41.

With respect to body weight variations, experiments performed by the inventors indicated that for a healthy adult, a weight loss (or gain) for one month that is an increase/decrease percentage of the present body weight within the predetermined range, or in other words, within 2% to 10%, will not be unhealthy. Accordingly, the present preferred embodiment is set so that the decrease amount over one month is an amount that is 2% to 10% of the present body weight.

Starting body weight data 45, shown in FIG. 6F, indicates a measured body weight from a starting date/time at which body weight management, such as a diet, was started, or in other words, it indicates a body weight measured at a date indicated by the target setting day data 42.

Thus, the body weight obtained by adding the long-term target increase/decrease amount data 43 to the starting body weight data 45 indicates the target body weight on the target date of body weight management completion, such as diet completion (i.e., the date obtained by adding the target completion period data 44 to the target setting day data 42).

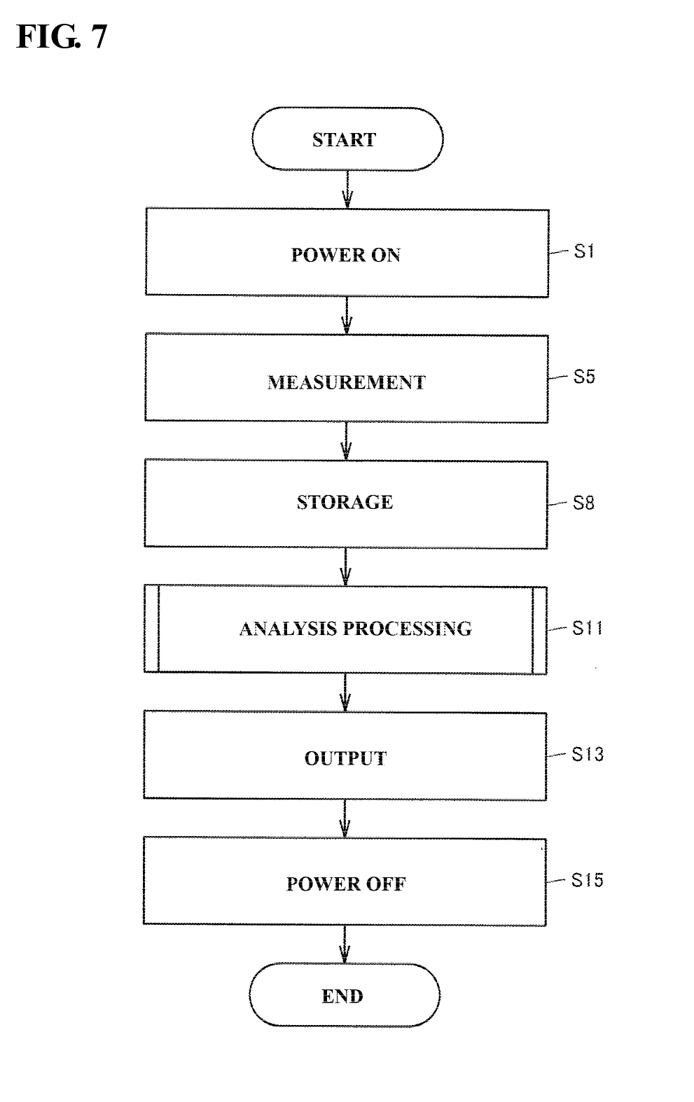

FIGS. 7 to 10 are flowcharts illustrating operations executed by the CPU 181 in the control unit 18 of the body weight/body composition meter 3. Here, processes for executing body weight management for the purpose of dieting will be described based on these flowcharts. These flowcharts are held in a memory in the control unit 18 or the storage unit 12 in advance as programs, and the processes are realized by the CPU 181 reading out the programs and executing the commands contained therein.

Note that the data 41 through the data 45 shown in FIG. 6 are assumed to be held in the storage unit 12 in advance. Is it assumed that the measurement subject measures his/her body weight only once every day at the evening time, and a sufficient amount of measurement data 40 from the date indicated in the target setting day data 42, for example, 10 days' worth of past measurement data, is already held in the storage unit 12.

As shown in FIG. 7, the CPU 181 starts up in response to the measurement subject inputting a power on instruction through the operating unit 14 (step S1), and, using the load detection unit 33, measures the body weight of the measurement subject who has stepped onto the upper surface cover unit 35 (see FIG. 1) (step S5). At this time, the CPU 181 can calculate body composition information based on the impedance detected by the impedance detection unit 20 (see FIG. 2) using the electrode units 36 of the body weight measurement unit 30 and the electrode units 21 of the display/operating unit 10. Also, the body weight value measured by the double integral AD unit 19, and the detected impedance value are input to the body weight obtainment unit 62 and the impedance obtainment unit 80. These input values are stored in association with each other in the storage unit 12 as the data 401 and the data 404 by the body weight storage unit 64 and the impedance storage unit 82, and the data 403 on the measurement date/time based on an output of the time measurement unit 13 stored in association with these pieces of data. Thus, the measurement data 40 obtained by the present body weight measurement is stored in the storage unit 12 (step S8).

The CPU 181 subsequently executes analysis processing of the measurement data 40 (step S11), and displays the analysis results including the target value on the display unit 15 (step S13). The CPU 181 subsequently turns the power supply off (step S15) and ends the processing.

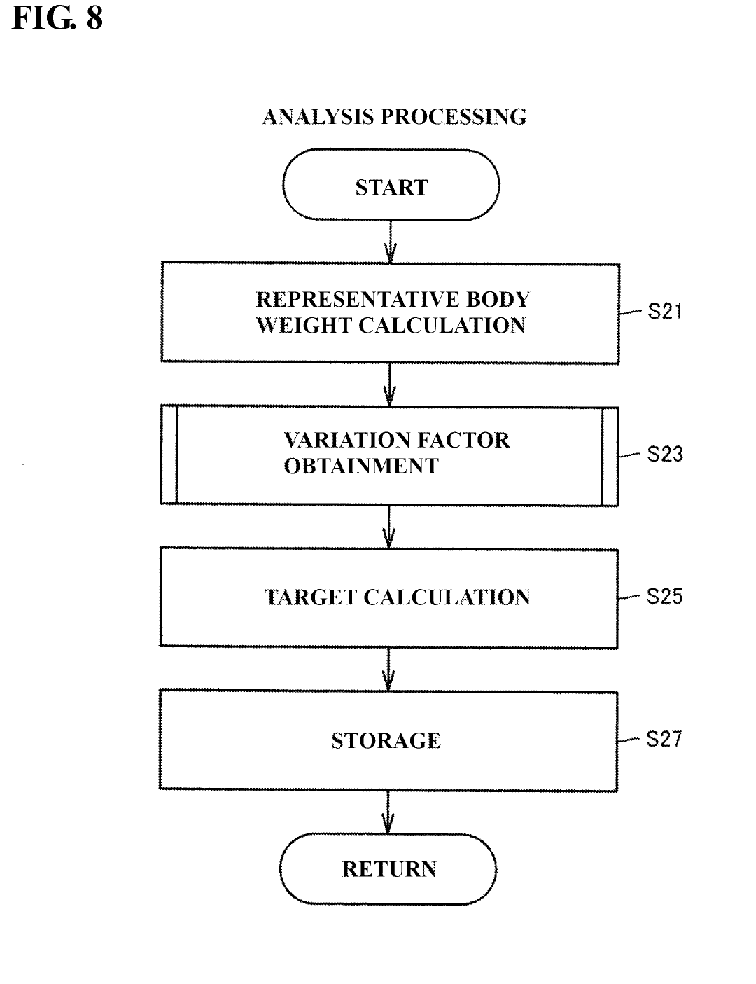

FIG. 8 is a flowchart illustrating the analysis process (see step S11 in FIG. 7). In the present preferred embodiment, the data 401 in the measurement data 40 measured in a predetermined period up to and including the day before the body weight measurement in step S5, or in other words, a predetermined period up to and including the most recent period (more preferably, the seven days up to and including the previous day) is read out from the memory unit 12 by the representative body weight calculation unit 66, and an average value is calculated as a representative value of measured body weight values indicated by the read-out seven days' worth of data 401 (step S21).

Next, an ingested amount of water, which is one factor causing body weight variation is obtained (step S23). That is to say, if a large amount of water is ingested during the day, body weight increases, but the ingested water is perspired during sleep due to the basal metabolism, and the body weight decreases by that amount by the following morning. In view of this, it is known that a temporary increase in the amount of body water does not contribute to a long-term increase in body weight. Thus, in order to obtain an accurate next-day target value, it is necessary to give consideration to the amount of water ingested and stored in the body during the day.

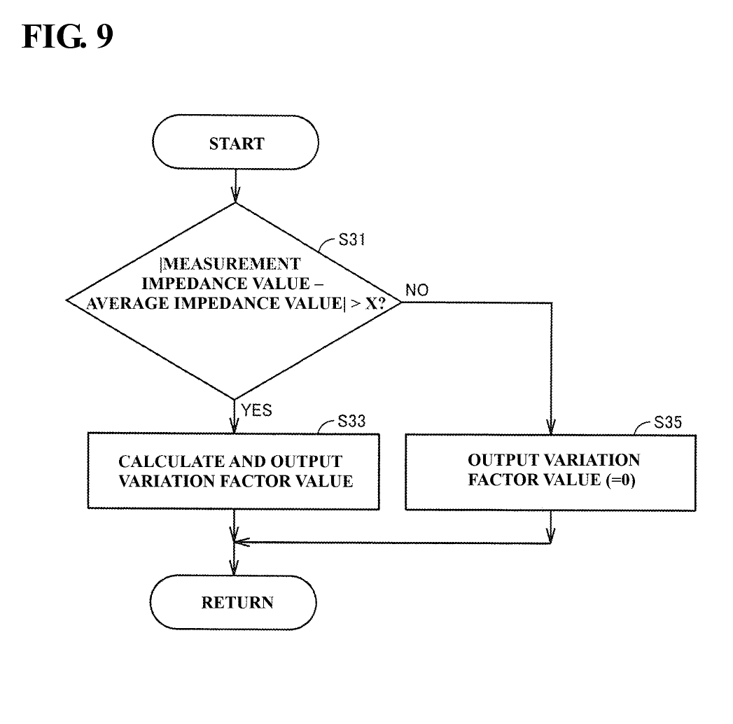

A process that obtains an amount of water in the measurement subject's body, performed by the variation factor obtainment unit 70, will be described with reference to the flowchart in FIG. 9.

The variation factor obtainment unit 70 calculates the difference between the impedance value obtained in step S5, and the representative impedance value calculated by the representative impedance calculation unit 84, and performs a comparison between that difference and a predetermined value X (for example, about 100Ω) (step S31). Here, similarly to the case of the body weight, the data 404 included in the measurement data 40 in a predetermined period up to and including the most recent period is read out from the storage unit 12 by the representative impedance calculation unit 84 as the representative body weight, an average value of the impedance values indicated by the read-out data 404 is calculated, and that average value is output as the representative impedance value.

Note that although about 100Ω was used as an example of the lowest value contributing to the variation in body weight, the present preferred embodiment is not limited to this, and the predetermined value X may be determined as a variable for each measurement subject, based on past impedance variations and body weight variations.

If the variation factor obtainment unit 70 determines that the condition (difference>predetermined value X) is satisfied based on the comparison results (YES in step S31), the variation factor=(water amount based on the impedance value measured in step S5−average water amount based on the representative impedance value) is calculated, and the calculated value is output as the variation factor (step S33). On the other hand, if it is determined that the condition (difference>predetermined value X) is not satisfied (NO in step S31), 0 (zero) is output as the variation factor (step S35). After the variation factor is output, processing returns to the original flow.

In this way, if the impedance value measured at the evening time is smaller than the representative impedance value in the most recent predetermined period (YES in step S31), it is in a state in which more water than normal has been ingested within the body, and therefore the nighttime body weight decrease is expected to be larger depending on metabolism. Thus, due to the influence of this amount of water, the body weight value measured at the evening time in step S5 is different from the original body weight, and therefore an accurate target value is to be calculated using this amount of water.

When the variation factor is obtained, the procedure returns to the processing in FIG. 8. The target calculation unit 68 calculates a target value by subtracting the value of the intra-day target weight-loss value data 41 from the calculated representative body weight value, and deducting the value of the variation factor from the value obtained by the subtraction (step S25). The calculated target value is stored as the data 402 in the measurement data 40 stored in step S8 (step S27). Subsequently, the procedure returns to the original processing in FIG. 7.

In the present preferred embodiment, the amount of body water may be calculated based on a variation in the impedance measured based on the relationship that states that the larger the amount of water in the body is, the smaller the body impedance is. For example, it is possible to use the calculation method disclosed in JP 2002-112976A.

In other words, an intracellular fluid amount ICw and an extracellular fluid amount ECw are calculated based on parameters Re and Ri, which are calculated based on the measured impedance, the height (H) input as personal information, and the weight (W) that was measured, and the body water amount TBw=ICw+ECw is calculated.

ICw=Ki1×H²/Ri+Ki2×W+Ki3

ECw=Ke1×H²/Re+Ke2×W+Ke3

TBw=ICw+ECw,

where Ki1, Ki2, Ki3, Ke1, Ke2, and Ke3 are predetermined coefficients. Also, since a method of calculating the parameters Re and Ri based on the measured body impedance is described in detail in JP 2002-112976A, it will not be described here.

The aforementioned variation factor obtainment unit 70 obtained an amount of ingested water based on the impedance as a measurement value that is a variation factor, but it is possible to use the variation factor obtainment unit 71 to obtain a body weight increase/decrease value, which is caused by fluctuations in body weight measurement time, as a measurement value that is a variation factor. In other words, since body weight varies according to the basal metabolism as well, it is necessary to use a body weight value measured in the same period of time, or more preferably at the same time every day in order to accurately calculate the target value.

In view of this, in order to obtain a body weight variation factor associated with the fluctuation in measurement times, the variation factor obtainment unit 71 calculates an hourly body weight decrease amount according to the measurement subject's basal metabolism. Specifically, using (measurement subject's single-day basal metabolism amount/24 hours), an hourly basal metabolism amount (Kcal) is calculated and the hourly basal metabolism amount that was calculated is converted into a body weight value. Here, a single-day basal metabolism amount can be calculated using a publicly-known function that uses the parameters of body weight, height, age, and sex.

Generally, 9 Kcal is required to burn 1 g of fat (however, since a person's fat contains 20% water, this number is approximately 7 Kcal), 4 Kcal is required to burn 1 g of carbohydrate, and 4 Kcal is required to burn 1 g of protein; accordingly, the variation factor obtainment unit 71 can calculate an hourly body weight decrease amount due to the measurement subject's basal metabolism, based on these consumed Kcal amounts and the calculated hourly basal metabolism amount.

As shown in FIG. 4, the variation factor obtainment unit includes the basal metabolism calculation unit 87 and a representative time calculation unit 86 configured to calculate a representative measurement time based on the measurement dates/times indicated by the data 403 in the measurement data 40 in the most recent predetermined time period, for example, the most recent seven-day period, which is stored in the storage unit 12. The basal metabolism calculation unit 87 calculates the difference between the calculated representative measurement time, and the measurement date/time of the most recent body weight data stored in the storage unit 12, or in other words, the measurement time of the body weight value measured in step S5, and calculates the measurement subject's basal metabolism amount using the difference that was calculated. The variation factor obtainment unit 71 converts the basal metabolism amount calculated by the basal metabolism calculation unit 87 into a body weight decrease amount according to the aforementioned procedure. The calculated body weight decrease amount is obtained as a measurement amount that is a variation factor.

Note that in order to accurately calculate a target value, the variation factor obtainment units 70 and 71 may both obtain measurement values that are variation factors and use an average value of those values as a final measurement value that is a variation factor.

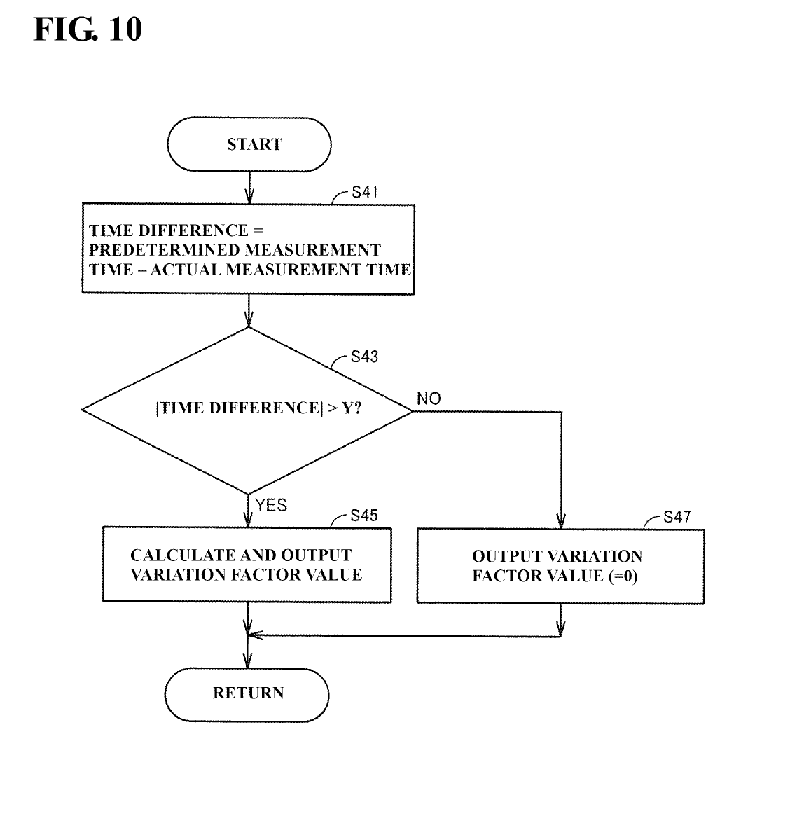

Processing performed by the variation factor obtainment unit 71 will be described below based on the flowchart in FIG. 10.

The variation factor obtainment unit 71 calculates the difference between the measurement time obtained in step S5, and the representative measurement time calculated by the representative time calculation unit 86 (step S41), and compares that difference to a predetermined value Y (step S43). Here, similarly to the case of the body weight, the representative time calculation unit 86 calculates the representative measurement time by reading out the data 404 in the measurement data 40 in a time period up to the most recent period, or more preferably, a seven-day period up to and including the previous day, from the storage unit 12, and calculating an average value as a representative value for the evening time, indicated by the read-out data 403 in a seven-day period.

If the variation factor obtainment unit 71 determines that the condition (difference>predetermined value Y) is fulfilled based on the comparison results (YES in step S43), the body weight decrease amount that corresponds to the measurement subject's basal metabolism amount for the difference time is calculated as a measurement value that is a variation factor, in accordance with the aforementioned processing, and it is output (step S45). On the other hand, if it is determined that the condition (difference>predetermined value Y) is not fulfilled (NO in step S43), 0 (zero) is output as the measurement value that is a variation factor (step S47). After the measurement value that is a variation factor is output, the processing returns to the original flow.

Thus, it is possible to obtain a body weight variation factor caused by a fluctuation in body weight measurement time, based on a basal metabolism amount.

Returning to FIG. 8, the target calculation unit 68 calculates the target value by subtracting the value of the intra-day target weight-loss value data 41 from the calculated representative body weight value, and deducting the measurement value that is a variation factor, which was obtained by the variation factor obtainment unit 71, from the value obtained by the subtraction (step S25). The calculated target value is stored as the data 402 in the measurement data 40 stored in step S8 (step S27). Subsequently, the procedure returns to the original processing in FIG. 7.

The aforementioned representative body weight calculation unit 66 calculated an average value for measured body weight values as a representative body weight value, but the calculation method is not limited to this.

The representative body weight calculation unit 66 may calculate a linear function equation (f(x)=Ax+B), or in other words, a regression equation, that expresses change in a time series for measured body weight values, based on the measured body weight values indicated in the data 401 in the most recent predetermined period, calculate an evening body weight from the previous day using the equation, and derive the calculated evening body weight from the previous day as a representative body weight value. For example, it is possible to calculate a representative body weight value, which is a body weight from a previous day, by assigning a measured body weight value indicated by the data 401 from the past seven days to the variable B in the equation, assigning the slope value of the equation to the variable A, assigning “7” to the variable x and calculating the value of the function f(x). Note that in the equation, the value of the variable x, which indicates the number of days in the predetermined period, is not limited to “7”, and may be “8” or more.

It is also possible to use an average of the body weights measured for each seven-day period as another method that uses a regression equation. Specifically, the representative body weight calculation unit 66 is programmed to: i) partition the predetermined recent period (of seven days or more) of the measurement data 40 in the storage unit 12, into unit periods of seven days for example, ii) calculate an average value of measured body weight values indicated by the data 401 for each partitioned unit period, iii) calculate a linear function equation (f(x)=A′x+B′), or in other words, a regression equation, indicating change in a time series for average values, and iv) calculate the body weight of the previous day based on that equation. The calculated body weight of the previous day is derived as a representative body weight value.

In the present preferred embodiment, the predicted value calculation unit 72 calculates predicted body weight values based on the measurement data 40 stored in the storage unit 12. The predicted value that was calculated is displayed on the display unit 15 via the output processing unit 73. The predicted body weight value can be calculated using the aforementioned regression equation.

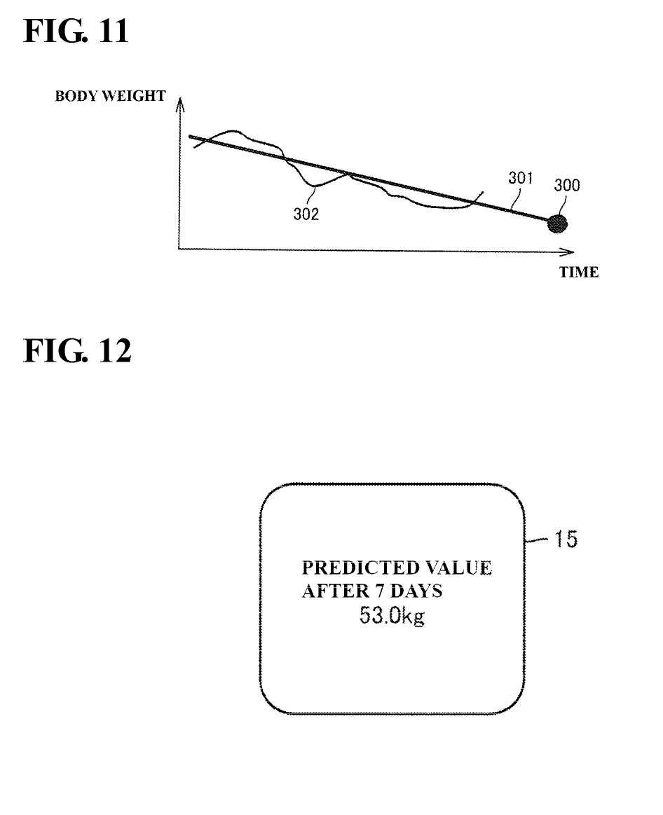

An example of a regression equation will be described based on FIG. 11. FIG. 11 illustrates a graph 302 indicating change in measured body weight values indicated by the data 401, and a graph 301 indicating a linear function equation (a regression equation) estimated from the graph 302, in which body weight values are on the vertical axis and time is on the horizontal axis.

The predicted value calculation unit 72 calculates a predicted body weight value using the equation (f(x)=Ax+B) of the graph 301 in FIG. 11. Specifically, the body weight value of the current day, which was measured in step S5, is calculated as the value CW, and the predicted body weight value after N days (where N is an integer greater than or equal to 1)=CW+(A×N) is calculated. The measurement subject can input the value of the variable “N” using the operating unit 14 (or the operating unit 31). Note that it is possible to predict a target value after N days (value 300 in FIG. 11) by subtracting the value of the intra-day target weight-loss value data 41 from the predicted body weight value after N days.

FIG. 12 illustrates a display example of the predicted body weight value on the display unit 15. The predicted target value after N days is also displayed on the display unit 15. The predicted target value may be displayed on the same screen as in FIG. 12, or the predicted target value after N days may be displayed on another screen.

By presenting the predicted body weight value in this way, it is possible to supply the measurement subject with a guide for determining the pace of weight loss.

The predicted value calculation unit 72 calculates a predicted next-day morning body weight value based on the body weight measured in step S5 and an average value of nighttime body weight decrease.

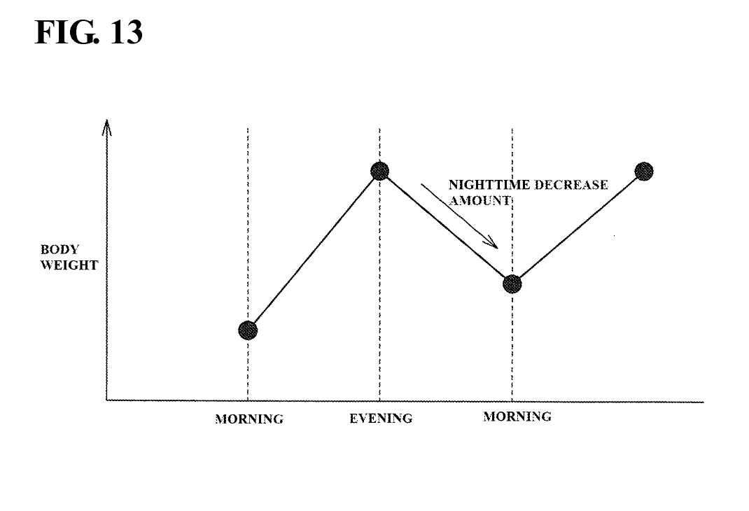

As shown in FIG. 13, there is a tendency for a person's body weight to increase from morning to evening, and to decrease from evening to morning due to the nighttime body weight decrease. In the present preferred embodiment, impedance is measured in the morning and in the evening in order to calculate the nighttime body weight decrease. The predicted value calculation unit 72 calculates morning and evening body water using the procedure shown in the above-described “Method of estimating amount of body water” using the measured impedance, and that difference is calculated as the nighttime body weight decrease value.

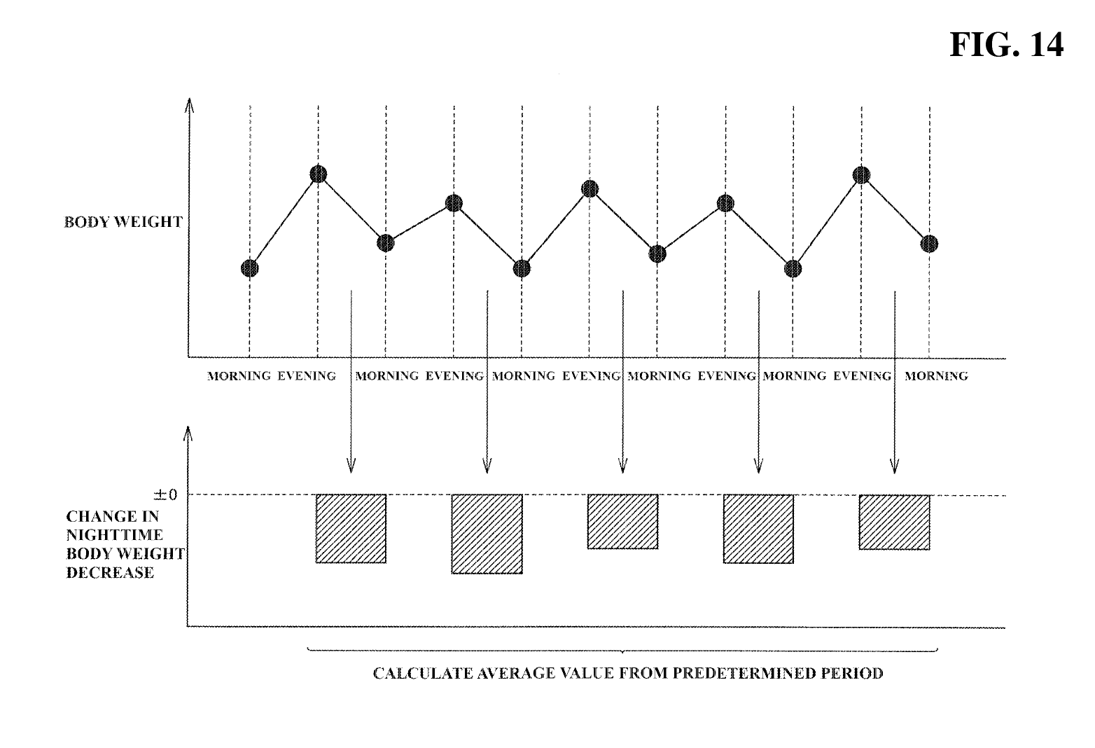

The predicted value calculation unit 72 obtains nighttime body weight decrease values in the most recent predetermined time period, and calculates an average value thereof (see FIG. 14). Then, by subtracting that average value from the body weight value measured in step S5, it is possible to obtain a predicted value for the morning body weight of the following day.

Also, the CPU 181 can obtain a target value for the next-day evening body weight by subtracting the value of the intra-day target weight-loss value data 41 from the predicted value for the next-day morning body weight.

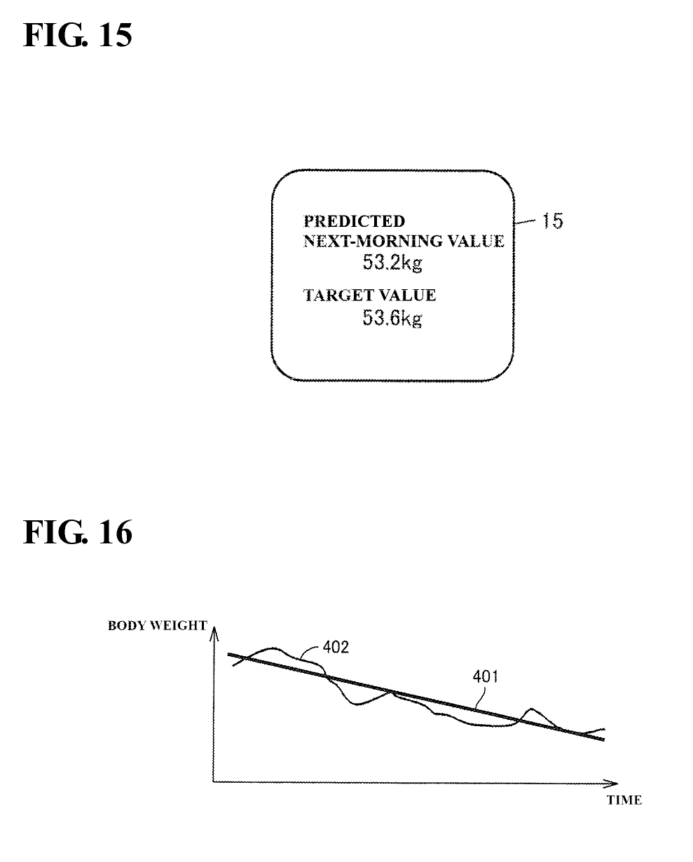

FIG. 15 illustrates a display example on the display unit 15 performed by the output processing unit 73. The predicted value for the next-day morning body weight calculated by the predicted value calculation unit 72, and a target value for the next-day evening body weight are displayed in FIG. 15.

In the aforementioned preferred embodiments, it was assumed that the body weight measured every day in step S5 was the evening body weight, but it may be assumed that the morning body weight is measured in place of the evening body weight, and that the target calculation unit 68 predicts a target value, which is the evening body weight, based on the morning body weight. Hereinafter, it is assumed that the body weight measured once every day is the morning body weight.

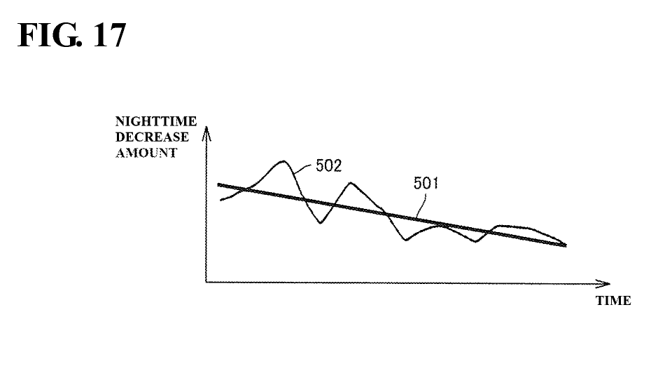

FIG. 16 illustrates a graph 402 indicating change in morning body weight indicated in the data 401, and a graph 401 indicating a linear function equation (a regression equation) estimated from the measurement values in the graph 402, in which body weight is on the vertical axis and time is on the horizontal axis. The graph 401 has a slope M. FIG. 17 illustrates a graph 502 indicating change in nighttime body weight decrease, and a graph 501 of a linear function equation (a regression equation) estimated from the values of the graph 502, in which nighttime body weight decrease is on the vertical axis and time is on the horizontal axis. The graph 501 has a slope L.

Accordingly, a target value, which is an evening body weight after N days, can be calculated based on the formula (morning body weight measured in step S5+(α×N×M+β×N×L)). Here, the variables α and β indicate weighting coefficients.

### OTHER PREFERRED EMBODIMENTS

In the aforementioned preferred embodiments, all calculations for body weight management are preferably performed by the body weight/body composition meter 3, but a configuration is possible in which they are performed with the server 5 in place of the body weight/body composition meter 3. Functions of the server 5 will be described below.

In the case where the calculations are performed with the server 5, the body weight/body composition meter 3 transmits the measurement data 40 to the server 5 during the storage processing in step S8. Then, the CPU 521 in the control unit 52 of the server obtains the measurement data 40 from the body weight/body composition meter 3, and executes processing according to the aforementioned flowcharts. Data is stored in the storage unit 55, and information is displayed on the display unit 54.

The server 5 may be configured to transmit information to be displayed on the screen of the display unit 54 to the body weight/body composition meter 3. The body weight/body composition meter 3 receives information from the server 5 and the received information is displayed on the display unit 15.

Functional configurations for weight management in the server 5 will be described below with reference to FIG. 5. FIG. 5 illustrates functions included in the CPU 521 and related peripheral circuits.

The CPU 521 preferably includes an operation reception unit 530 configured and programmed to receive a user operation via the operating unit 53 and output an operation signal based on the received operation, a body weight obtainment unit 532 configured and programmed to obtain the measurement data 40 transmitted from the body weight/body composition meter 3, a body weight storage unit 534 configured and programmed to store the obtained measurement data 40 in a predetermined region of the storage unit 55, a representative body weight calculation unit 536, a target calculation unit 538, a variation factor obtainment unit 540 configured and programmed to obtain a measurement value to be a body weight variation factor, a predicted value calculation unit 542 configured and programmed to calculate a predicted body weight value, an output processing unit 543 configured and programmed to display information on the display unit 54, and a communication processing unit 544 configured and programmed to communicate with external devices, including the body weight/body composition meter 3, via the communication unit 51.

These elements have functions similar to those of the corresponding elements in FIG. 3.

The elements in FIG. 5 are realized by programs executed by the CPU 521. These programs are stored in advance in the ROM (not shown) of the control unit 52. The functions of the respective elements are realized by the CPU 521 reading out the programs from the ROM and executing the commands in the read-out programs. It may be assumed that the programs are downloaded by the communication unit 51 from an external device such as a server (not shown), are stored in the storage unit 55, and are subsequently read out from the storage unit 55 by the CPU 521 and executed.

In addition, although the aforementioned preferred embodiments describes the basal metabolism amount and the body water being calculated based on the measurement subject's impedance as detected by the impedance detection unit 20, the calculated body composition information is not limited to the basal metabolism amount or the like. For example, a body fat percentage, BMI (Body Mass Index), visceral fat level, skeletal muscle percentage, body age, and so on may be calculated based on the body impedance, the height, age, and sex of the measurement subject stored in the storage unit 12, and the body weight detected by the load detection unit 33, and that calculated information may output along with the body weight.

Furthermore, the stated body weight management method carried out by the body weight/body composition meter 3 according to the present preferred embodiment can also be provided as a program.

This program can also be recorded non-temporarily on a computer-readable recording medium, such as a flexible disk provided to the computer of the control unit 18 or the control unit 52, a CD-ROM (compact disk read-only memory), a ROM, a RAM, a memory card, and so on, and can then be provided as a program product. Alternatively, the program can be recorded on a recording medium such as a hard disk mounted within a computer, and can be provided in such form as a program.

Further still, the program can also be downloaded via a network, and can be provided in such form as a program.

The provided program product is installed in a program storage unit such as a hard disk or the like and is then read out and executed by the CPU 181 (or 521). Note that the program product includes the program itself and the recording medium on which the program is recorded.

Note that the preferred embodiments disclosed above are to be understood as being in all ways exemplary and in no way limiting. The scope of the present invention is defined not by the aforementioned descriptions but by the scope of the appended claims, and all changes that fall within the same essential spirit as the scope of the claims are intended to be included therein as well.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-10. (canceled)

11. A body weight measurement device comprising:
a body weight obtainment unit configured to obtain body weight data that includes a measurement subject's body weight measurement value at an intra-day predetermined timing between waking up and sleeping, and a measurement date/time of the body weight measurement value;
a body weight storage unit configured to store the body weight data obtained by the body weight obtainment unit in a memory;
a representative body weight calculation unit configured to calculate a representative body weight value based on the body weight measurement values in the body weight data in a predetermined period that are stored in the memory; and
a target calculation unit configured to calculate a target value to be a target when a body weight value is measured at the predetermined timing, based on the calculated representative body weight value, an intra-day target weight-loss value, and a measurement value to be a body weight variation factor.

12. The body weight management device according to claim 11, further comprising:
a variation factor obtainment unit configured to obtain a measurement value to be a body weight variation factor; wherein
the variation factor obtainment unit includes:
an impedance obtainment unit configured to obtain impedance data that includes a body impedance value of a measurement subject measured at the predetermined timing, and a measurement date/time of the body impedance value;
an impedance storage unit configured to store the impedance data obtained by the impedance obtainment unit in a memory; and
a representative impedance calculation unit configured to calculate a representative impedance value based on impedance values in the impedance data in the predetermined time period that are stored in the memory; wherein
an amount of body water based on a differential impedance value obtained using the representative impedance value that was calculated, and a most recent impedance value in the impedance data stored in the memory is calculated as the measurement value to be a body weight variation factor.

13. The body weight management device according to claim 11, further comprising:
a variation factor obtainment unit configured to obtain the measurement value to be a body weight variation factor; wherein
the variation factor obtainment unit includes:
a representative time calculation unit configured to calculate a representative measurement time based on measurement dates/times in the body weight data in the predetermined time period that are stored in the memory; and
a basal metabolism calculation unit configured to calculate a measurement subject's basal metabolism amount in a differential time obtained using the representative measurement time that was calculated, and a measurement time indicated by the most recent measurement date/time in the body weight data stored in the memory; wherein
a body weight value based on the basal metabolism amount that was calculated is calculated as the measurement value to be a body weight variation factor.

14. The body weight management device according to claim 11, wherein the representative body weight calculation unit is configured to calculate an average of body weight measurement values in the body weight data in the predetermined time period that are stored in the memory, as the representative body weight value.

15. The body weight management device according to claim 11, wherein the representative body weight calculation unit is configured to obtain a regression equation based on body weight measurement values in the body weight data in the predetermined time period that are stored in the memory, and calculate the most recent body weight value according to the regression equation as the representative body weight value.

16. The body weight management device according to claim 11, wherein the predetermined timing is a timing that is closer to when the measurement subject sleeps, in a range from when the measurement subject wakes up to when the measurement subject sleeps.

17. The body weight management device according to claim 11, further comprising a predicted body weight calculation unit configured to calculate a predicted next-day post-waking body weight value using a pre-sleep body weight value, which is a body weight measurement value at the timing that is closer to when the measurement subject sleeps, and a representative value for a sleeping body weight decrease amount in the predetermined time period.

18. The body weight management device according to claim 17, wherein the predicted body weight calculation unit is configured to obtain a first body impedance value measured at a timing that is closer to when the measurement subject sleeps, and a second body impedance value measured at a timing that is closer to when the measurement subject wakes up on the following day, and calculates the sleeping body weight decrease amount in accordance with a predetermined replacement function, using the first and second obtained body impedance values.

19. The body weight management device according to claim 18, wherein the predicted body weight calculation unit is configured to obtain a first regression equation based on body weight measurement values in the body weight data in the predetermined time period that are stored in the memory, and a second regression equation based on the sleeping body weight decrease amount in the predetermined time period, and calculates a predicted body weight value after N days using the first and second obtained regression equations.
